(19) United States
(12) Patent Application Publication
(10) Pub. No.: US 2009/0119594 A1
(43) Pub. Date: May 7, 2009

(54) FAST AND EDITING-FRIENDLY SAMPLE ASSOCIATION METHOD FOR MULTIMEDIA FILE FORMATS

(75) Inventor: Miska Hannuksela, Ruutana (FI)

Correspondence Address: FOLEY & LARDNER LLP, P.O. BOX 80278, SAN DIEGO, CA, 92138-0278, US

(73) Assignee: Nokia Corporation

(21) Appl. No.: 12/260,038

(22) Filed: Oct. 28, 2008

Related U.S. Application Data
(60) Provisional application No. 60/983,552, filed on Oct. 29, 2007.

(51) Int. Cl. G06F 3/00

(52) U.S. Cl. 715/723

(57) ABSTRACT

Systems and methods for using sample numbers to pair timed metadata samples with media or hint samples is provided. A timed metadata sample can be paired with media or hint samples since a sample number contained in the time media sample is provided relative to the appropriate media or hint track. Additionally, an offset of sample numbers, applicable to scenarios where a plurality of timed metadata samples exist, may be added to the provided sample number to obtain the actual sample number within the media or hint track.

### CROSS-REFERENCE TO RELATED PATENT APPLICATIONS

This application claims priority from Provisional Application U.S. Application 60/983,552, filed Oct. 29, 2007, incorporated herein by reference in its entirety.

### FIELD OF THE INVENTION

The present invention relates generally to the multimedia file formats. More particularly, the present invention relates to the pairing of timed metadata samples with media and/or hint samples for organizing media and/or multimedia data.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The multimedia container file format is an important element in the chain of multimedia content production, manipulation, transmission and consumption. In this context, the coding format (i.e., the elementary stream format) relates to the action of a specific coding algorithm that codes the content information into a bitstream. The container file format comprises mechanisms for organizing the generated bitstream in such a way that it can be accessed for local decoding and playback, transferring as a file, or streaming, all utilizing a variety of storage and transport architectures. The container file format can also facilitate the interchanging and editing of the media, as well as the recording of received real-time streams to a file. As such, there are substantial differences between the coding format and the container file format.

The hierarchy of multimedia file formats is depicted generally at 100 in FIG. 1. The elementary stream format 110 represents an independent, single stream. Audio files such as .amr and .aac files are constructed according to the elementary stream format. The container file format 120 is a format which may contain both audio and video streams in a single file. An example of a family of container file formats 120 is based on the ISO base media file format. Just below the container file format 120 in the hierarchy 100 is the multiplexing format 130. The multiplexing format 130 is typically less flexible and more tightly packed than an audio/video (AV) file constructed according to the container file format 120. Files constructed according to the multiplexing format 130 are typically used for playback purposes only. A Moving Picture Experts Group (MPEG)-2 program stream is an example of a stream constructed according to the multiplexing format 130. The presentation language format 140 is used for purposes such as layout, interactivity, the synchronization of AV and discrete media, etc. Synchronized multimedia integration language (SMIL) and scalable video graphics (SVG), both specified by the World Wide Web Consortium (W3C), are examples of a presentation language format 140. The presentation file format 150 is characterized by having all parts of a presentation in the same file. Examples of objects constructed according to a presentation file format are PowerPoint files and files conforming to the extended presentation profile of the 3GP file format.

Available media and container file format standards include the ISO base media file format (ISO/IEC 14496-12), the MPEG-4 file format (ISO/IEC 14496-14, also known as the MP4 format), Advanced Video Coding (AVC) file format (ISO/IEC 14496-15) and the 3GPP file format (3GPP TS 26.244, also known as the 3GP format). There is also a project in MPEG for development of the scalable video coding (SVC) file format, which will become an amendment to advanced video coding (AVC) file format. In a parallel effort, MPEG is defining a hint track format for file delivery over unidirectional transport (FLUTE) and asynchronous layered coding (ALC) sessions, which will become an amendment to the ISO base media file format.

The Digital Video Broadcasting (DVB) organization is currently in the process of specifying the DVB file format. The primary purpose of defining the DVB file format is to ease content interoperability between implementations of DVB technologies, such as set-top boxes according to current (DVT-T, DVB-C, DVB-S) and future DVB standards, Internet Protocol (IP) television receivers, and mobile television receivers according to DVB-Handheld (DVB-H) and its future evolutions. The DVB file format will allow the exchange of recorded (read-only) media between devices from different manufacturers, the exchange of content using USB mass memories or similar read/write devices, and shared access to common disk storage on a home network, as well as other functionalities. The ISO base media file format is currently the strongest candidate as the basis for the development of the DVB file format. The ISO file format is the basis for the derivation of all the above-referenced container file formats (excluding the ISO file format itself). These file formats (including the ISO file format itself) are referred to as the ISO family of file formats.

The basic building block in the ISO base media file format is called a box. Each box includes a header and a payload. The box header indicates the type of the box and the size of the box in terms of bytes. A box may enclose other boxes, and the ISO file format specifies which box types are allowed within a box of a certain type. Furthermore, some boxes are mandatorily present in each file, while other boxes are simply optional. Moreover, for some box types, there can be more than one box present in a file. Therefore, the ISO base media file format essentially specifies a hierarchical structure of boxes.

FIG. 2 shows a simplified file structure according to the ISO base media file format. According to the ISO family of file formats, a file 200 includes media data and metadata that are enclosed in separate boxes, the media data (mdat) box 210 and the movie (moov) box 220, respectively. For a file to be operable, both of these boxes must be present. The media data box 210 contains video and audio frames, which may be interleaved and time-ordered. The movie box 220 may contain one or more tracks, and each track resides in one track box 240. A track can be one of the following types: media, hint or timed metadata. A media track refers to samples formatted according to a media compression format (and its encapsulation to the ISO base media file format). A hint track refers to hint samples, containing cookbook instructions for constructing packets for transmission over an indicated communication protocol. The cookbook instructions may contain guidance for packet header construction and include packet payload construction. In the packet payload construction, data residing in other tracks or items may be referenced (e.g., a reference may indicate which piece of data in a particular track or item is instructed to be copied into a packet during the packet construction process). A timed metadata track refers to samples describing referred media and/or hint samples. For the presentation of one media type, typically one track is selected.

Additionally, samples of a track are implicitly associated with sample numbers that are incremented by 1 in an indicated decoding order of samples. Therefore, the first sample in a track can be associated with sample number “1.” It should be noted that such an assumption affects certain formulas, but one skilled in the art would understand to modify such formulas accordingly for other “start offsets” of sample numbers, e.g., sample number “0.”

It should be noted that the ISO base media file format does not limit a presentation to be contained in only one file. In fact, a presentation may be contained in several files. In this scenario, one file contains the metadata for the whole presentation. This file may also contain all of the media data, in which case the presentation is self-contained. The other files, if used, are not required to be formatted according to the ISO base media file format. The other files are used to contain media data, and they may also contain unused media data or other information. The ISO base media file format is concerned with only the structure of the file containing the metadata. The format of the media-data files is constrained by the ISO base media file format or its derivative formats only in that the media-data in the media files must be formatted as specified in the ISO base media file format or its derivative formats.

Movie fragments can be used when recording content to ISO files in order to avoid losing data if a recording application crashes, runs out of disk, or some other incident happens. Without movie fragments, data loss may occur because the file format insists that all metadata (the Movie Box) be written in one contiguous area of the file. Furthermore, when recording a file, there may not be sufficient amount of RAM to buffer a Movie Box for the size of the storage available, and re-computing the contents of a Movie Box when the movie is closed is too slowly. Moreover, movie fragments can enable simultaneous recording and playback of a file using a regular ISO file parser. Finally, a smaller duration of initial buffering is required for progressive downloading (e.g., simultaneous reception and playback of a file, when movie fragments are used and the initial Movie Box is smaller in comparison to a file with the same media content but structured without movie fragments).

The movie fragment feature enables splitting of the metadata that conventionally would reside in the moov box 220 to multiple pieces, each corresponding to a certain period of time for a track. Thus, the movie fragment feature enables interleaving of file metadata and media data. Consequently, the size of the moov box 220 can be limited and the use cases mentioned above be realized.

The media samples for the movie fragments reside in an mdat box 210, as usual, if they are in the same file as the moov box. For the meta data of the movie fragments, however, a moof box is provided. It comprises the information for a certain duration of playback time that would previously have been in the moov box 220. The moov box 220 still represents a valid movie on its own, but in addition, it comprises an mvex box indicating that movie fragments will follow in the same file. The movie fragments extend the presentation that is associated to the moov box in time.

The metadata that can be included in the moof box is limited to a subset of the metadata that can be included in a moov box 220 and is coded differently in some cases.

In addition to timed tracks, ISO files can contain any non-timed binary objects in a meta box, or “static” metadata. The meta box can reside at the top level of the file, within a movie box, and within a track box. At most one meta box may occur at each of the file level, movie level, or track level. The meta box is required to contain a ‘hdlr’ box indicating the structure or format of the “meta” box contents. The meta box may contain any number of binary items that can be referred and each one of them can be associated with a file name.

In order to support more than one meta box at any level of the hierarchy (file, movie, or track), a meta box container box (‘meco’) has been introduced in the ISO base media file format. The meta box container box can carry any number of additional meta boxes at any level of the hierarchy (file, move, or track). This allows, for example, the same meta-data to be presented in two different, alternative, meta-data systems. The meta box relation box (“mere”) enables describing how different meta boxes relate to each other (e.g., whether they contain exactly the same metadata, but described with different schemes, or if one represents a superset of another).

Referring to FIGS. 3 and 4, the use of sample grouping in boxes is illustrated. A sample grouping in the ISO base media file format and its derivatives, such as the AVC file format and the SVC file format, is an assignment of each sample in a track to be a member of one sample group, based on a grouping criterion. A sample group in a sample grouping is not limited to being contiguous samples and may contain non-adjacent samples. As there may be more than one sample grouping for the samples in a track, each sample grouping has a type field to indicate the type of grouping. Sample groupings are represented by two linked data structures: (1) a SampleToGroup box (sbgp box) represents the assignment of samples to sample groups; and (2) a SampleGroupDescription box (sgpd box) contains a sample group entry for each sample group describing the properties of the group. There may be multiple instances of the SampleToGroup and SampleGroupDescription boxes based on different grouping criteria. These are distinguished by a type field used to indicate the type of grouping.

FIG. 3 provides a simplified box hierarchy indicating the nesting structure for the sample group boxes. The sample group boxes (SampleGroupDescription Box and SampleToGroup Box) reside within the sample table (stbl) box, which is enclosed in the media information (minf), media (mdia), and track (trak) boxes (in that order) within a movie (moov) box.

The SampleToGroup box is allowed to reside in a movie fragment. Hence, sample grouping can be done fragment by fragment. FIG. 4 illustrates an example of a file containing a movie fragment including a SampleToGroup box.

The DVB file format is intended as an interchange format (as described above) to ensure interoperability between compliant DVB devices. It is not necessarily intended as an internal storage format for DVB compatible devices. The DVB File Format will allow movement of recorded (read only) media between devices from different manufacturers and shared access to common disk storage on a home network, among other things.

A key feature of the DVB file format is known as reception hint tracks, which may be used when one or more packet streams of data are recorded according to the DVB file format. Reception hint tracks indicate the order, reception timing, and contents of the received packets among other things. Players for the DVB file format may re-create the packet stream that was received based on the reception hint tracks and process the re-created packet stream as if it was newly received. Reception hint tracks have an identical structure compared to hint tracks for servers, as specified in the ISO base media file format. For example, reception hint tracks may be linked to the elementary stream tracks (i.e., media tracks) they carry, by track references of type ‘hint’. Each protocol for conveying media streams has its own reception hint sample format.

Servers using reception hint tracks as hints for sending of the received streams should handle the potential degradations of the received streams, such as transmission delay jitter and packet losses, gracefully and ensure that the constraints of the protocols and contained data formats are obeyed regardless of the potential degradations of the received streams.

The sample formats of reception hint tracks may enable constructing of packets by pulling data out of other tracks by reference. These other tracks may be hint tracks or media tracks. The exact form of these pointers is defined by the sample format for the protocol, but in general they consist of four pieces of information: a track reference index, a sample number, an offset, and a length. Some of these may be implicit for a particular protocol. These ‘pointers’ always point to the actual source of the data. If a hint track is built ‘on top’ of another hint track, then the second hint track must have direct references to the media track(s) used by the first where data from those media tracks is placed in the stream.

The conversion of received streams to media tracks allows existing players compliant with the ISO base media file format to process DVB files as long as the media formats are also supported. However, most media coding standards only specify the decoding of error-free streams, and consequently it should be ensured that the content in media tracks can be correctly decoded. Players for the DVB file format may utilize reception hint tracks for handling of degradations caused by the transmission, i.e., content that may not be correctly decoded is located only within reception hint tracks. The need for having a duplicate of the correct media samples in both a media track and a reception hint track can be avoided by including data from the media track by reference into the reception hint track.

Currently, two types of reception hint tracks are being specified: MPEG-2 transport stream (MPEG2-TS) and Real-Time Transport Protocol (RTP) reception hint tracks. Samples of an MPEG2-TS reception hint track contain MPEG2-TS packets or instructions to compose MPEG2-TS packets from references to media tracks. An MPEG-2 transport stream is a multiplex of audio and video program elementary streams and some metadata information. It may also contain several audiovisual programs. An RTP reception hint track represents one RTP stream, typically a single media type.

RTP is used for transmitting continuous media data, such as coded audio and video streams in networks based on the Internet Protocol (IP). The Real-time Transport Control Protocol (RTCP) is a companion of RTP, i.e. RTCP should be used to complement RTP always when the network and application infrastructure allow. RTP and RTCP are usually conveyed over the User Datagram Protocol (UDP), which, in turn, is conveyed over the Internet Protocol (IP). There are two versions of IP, IPv4 and IPv6, differing by the number of addressable endpoints among other things. RTCP is used to monitor the quality of service provided by the network and to convey information about the participants in an on-going session. RTP and RTCP are designed for sessions that range from one-to-one communication to large multicast groups of thousands of endpoints. In order to control the total bitrate caused by RTCP packets in a multiparty session, the transmission interval of RTCP packets transmitted by a single endpoint is proportional to the number of participants in the session. Each media coding format has a specific RTP payload format, which specifies how media data is structured in the payload of an RTP packet.

The metadata requirements for the DVB file format can be classified to four groups based on the type of the metadata: 1) sample-specific timing metadata, such as presentation timestamps; 2) indexes; 3) segmented metadata; and 4) user bookmarks (e.g., of favorite locations in the content).

An example of sample-specific timing metadata are presentation timestamps. There can be different timelines to indicate sample-specific timing metadata. Timelines need not cover the entire length of the recorded streams and timelines may be paused. For example, in an example scenario, timeline A can be created in a final editing phase of a movie. Later, a service provider can insert commercials and provide a timeline B for those commercials. As a result, timeline A may be paused while the commercials are ongoing. Timelines can also be transmitted after the content itself. One mechanism for timeline sample carriage involves carrying timeline samples within the MPEG-2 program elementary streams (PES). A PES conveys an elementary audio or video bitstream, and hence timelines are accurately synchronized with audio and video frames.

Indexes may include, for example, video access points and trick mode support (e.g., fast forward/backward, slow-motion). Such operations may require, for example, indication of self-decodable pictures, decoding start points, and indications of reference and non-reference pictures.

In the case of segmented metadata, the DVB services may be described with a service guide according to a specific metadata schema, such as Broadcast Content Guide (BCG), TV-Anytime, or Electronic Service Guide (ESG) for IP datacasting (IPDC). The description may apply to a part of the stream only. Hence, the file may have several descriptive segments (e.g., a description about that specific segment of the program, such as “Holiday in Corsica near Cargese”) information.

In addition, the metadata and indexing structures of the DVB file format are required to be extensible and user-defined indexes are required to be supported.

Various techniques for performing indexing and implementing segmented metadata have been proposed, which include, for example, timed metadata tracks, sample groups, a DVBIndexTable, virtual media tracks, as well as sample events and sample properties. With regard to timed metadata tracks, one or more timed metadata tracks are created. A track can contain indexes of a particular type or can contain indexes of any type. In other words, the sample format would enable multiplexing of different index types. A track can also contain indexes of one program (e.g., of a multi-program transport stream) or many programs. Further still, a track can contain indexes of one media type or many media types.

As for sample groups, one sample grouping type can be dedicated for each index type, where the same number of sample group description indexes are included in the Sample Group Description Box as there are different values for a particular index type. A Sample to Group Box is used to associate samples to index values. The sample group approach can be used together with timed metadata tracks.

As to the DVBIndexTable, the DVBIndexTable box is introduced into the Sample Table Box. The DVBIndexTable box contains a list of entries, wherein each entry is associated with a sample in a reception hint track through its sample number. Each entry further contains information about the accuracy of the index, which program of a multi-program MPEG-2 transport stream it concerns, which timestamp it corresponds to, and the value(s) of the index(es).

With regard to virtual media tracks, it has been proposed that virtual media tracks are to be composed from reception hint tracks by referencing the sample data of the reception hint tracks. Consequently, the indexing mechanisms for media tracks, such as the sync sample box could be indirectly used for the received media.

Lastly, with regard to the sample events and sample properties technique, it has been proposed to overcome two inherent shortcomings of sample groups (when they are used for indexing). First, a Sample to Group Box uses run-length coding to associate samples to group description indexes. In other words, the number of consecutive samples mapped to the same group description index is provided. Thus, in order to resolve group description indexes in terms of absolute sample numbers, a cumulative sum of consecutive sample counts is calculated. Such a calculation may be a computational burden for some implementations. Therefore, the proposed technique uses absolute sample numbers in the Sample to Event and Sample to Property Boxes (which correspond to the Sample to Group Box) rather than run-length coding. Second, the Sample Group Description Box resides in the Movie Box. Consequently, either the index values have to be known at the start of the recording (which may not be possible for all index types) or the Movie Box has to be constantly updated during recording to respond new index values. The updating of the Movie Box therefore, may require moving other boxes (such as the mdat box) within the file, which may be a slow file operation. The proposed Sample to Property Box includes a property value field, which practically carries the index value, and can reside in every movie fragment. Hence, the original Movie Box need not be updated due to new index values.

Various methods can be utilized to pair samples from different tracks, i.e., associate samples of different tracks with each other in accordance with the ISO base media file format and its derivatives. A first method, referred to as ‘common playback timeline,’ is effectuated when media tracks are synchronized according to composition timestamps of the media samples, which are assumed to appear on the same timeline. In other words, samples are not actually associated with each other, but rather just presented synchronously.

Alternatively, a method referred to as ‘same decoding time’ can be utilized when a timed metadata track contains a track reference to the media or hint track it describes. A timed metadata sample is usually associated with a media sample through the decoding time, i.e., corresponding samples have the same decoding timestamp indicated by the Decoding Time to Sample Box (of both tracks).

Yet another method for pairing samples from different tracks is referred to as ‘same sample number,’ which provides for the possibility of associating a timed metadata sample to a media sample by including the sample number of the media sample to the timed metadata sample. A similar mechanism is available as one of the packet constructors for RTP hint tracks. Another example is the SVC file format, which includes an extractor mechanism similar to including sample data by reference to hint samples.

Furthermore, a method referred to as ‘decoding time+sample-specific sample number offset’ can be utilized, where one SVC track can include data by reference using the extractor mechanism from another SVC track. For example, one SVC track contains a base layer of a scalable bitstream, which can be included by reference to another SVC track. A sample (referred herein as the destination sample) containing an extractor is first associated through its decoding time to a sample in the referred track having sample number referred to as candidate source sample number. Then, a sample number offset contained in the destination sample is added to the candidate source sample number to obtain the associated sample number.

Simple processes for the indexing mechanism of the DVB File Format are generally desirable. However, a characteristic feature of the indexing mechanism is to pair an index and a reception hint sample (or a media sample in some cases). Consequently, it is also desirable not to have any series of operations, such as a repetitive sum, to resolve the reception hint sample for a particular index.

In accordance with the common playback timeline method described above, the pairing of samples from different tracks is possible only after the Decoding Time to Sample Box and Composition Time to Sample Box are parsed in both tracks. The Decoding Time to Sample Box is differentially coded, i.e., rather than indicating an absolute decoding timestamp for each sample, a sample duration for each sample is provided. Consequently, in order to resolve the decoding timestamp for a particular sample, all the sample durations of the preceding samples must be summed up—which is a computational burden. Furthermore, composition timestamps are irrelevant for timed metadata samples, as they are rarely presented, if ever.

The same decoding time method requires the parsing of the Decoding Time to Sample Boxes of both tracks, which is a computational burden, as explained above. Likewise, the same sample number method also results in complex editing operations because whenever samples are inserted to or removed from a media track, the sample numbers included in the timed metadata track must be rewritten. In other words, all timed metadata samples after the editing point must be traversed and their content must be edited. Moreover, the ‘decoding time+sample-specific sample number offset’ method, like the same decoding time method, requires parsing of the Decoding Time to Sample Boxes of both tracks, which is a computational burden.

It should be noted that file editing operations can be realized through Edit List Boxes. Edit List Boxes specify how a media composition timeline is converted to a playback timeline, and enable splitting of the media timeline to sections and mapping those sections to time-slices in the playback timeline. Hence, Edit List Boxes make it possible to omit media samples from playback, change the order of media sections in playback, and change the playback rate of media sections. However, Edit List Boxes are not supported by all players, because, for example, the flexibility of the features provided by Edit List Boxes causes challenges for player implementations. Furthermore, the use of Edit List Boxes does not enable the storage space used for the unplayed media samples or the description of the unplayed media samples in the moov box and moof boxes to be freed. Consequently, conventional file editors do not generally use Edit List Boxes, but rather modify files via other methods.

### SUMMARY OF THE INVENTION

Various systems and methods for organizing media and/or multimedia data in are provided in accordance with various embodiments. A first and second sample is stored in a file, wherein the first and second samples can be included (by reference) in, for example, a media or hint track. The first sample is associated with a first piece of data and the second sample is associated with a second piece of data, where the first and second pieces of data are representative portions of the media or hint tracks. A first sample number is associated with the first sample and a second sample number is associated with the second sample, where the first and second sample numbers are contained in, for example, a timed metadata sample, and are relative to the media and/or hint tracks. A sample number offset is included in the file and a first base sample number associated with the first piece of data is also included in the file. The sample number offset is applicable to a plurality of timed metadata samples. It should be noted that the first sample number is to be derivable from the sample number offset and the first base sample number. In one derivation method of the first sample number from the sample number offset and the first base sample number, the sample number offset is added to the first base sample number to obtain the first sample number, i.e., an actual first sample number within the media or hint track. Additionally, a second base sample number associated with the second piece of data is included in the file, where the second sample number is to be derivable from the sample number offset and the second base sample number in the same manner as described with regard to the first base sample number.

Because the sample number offset is utilized, as described above, sample numbers in timed metadata samples need not be overwritten after the insertion or removal of samples. Hence, various embodiments can, for example, simplify editing operations, especially with respect to the removal of the beginning of a recording, which can oftentimes be among the most used features of applicable editing operations.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a depiction of the hierarchy of multimedia file formats;

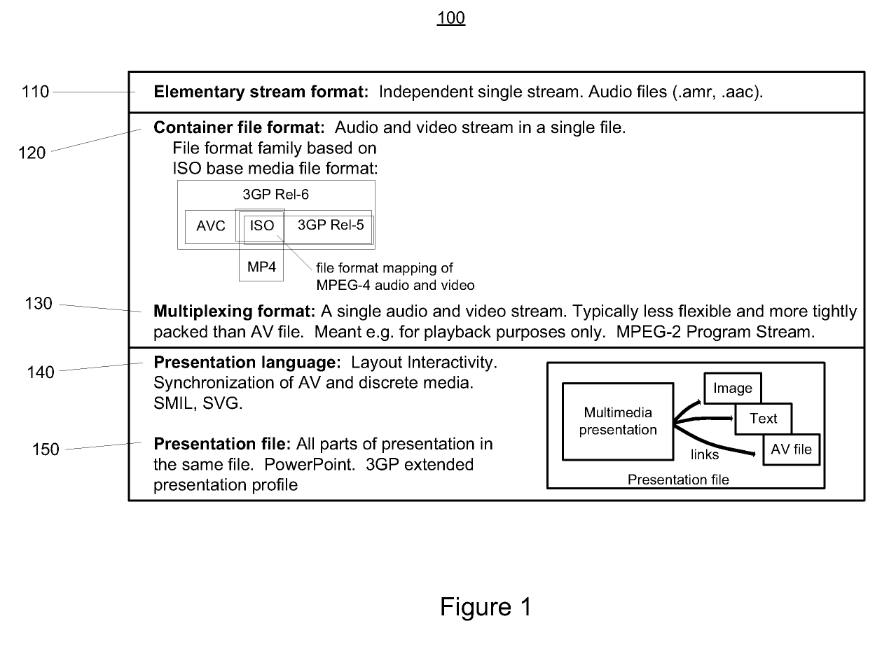

FIG. 2 illustrates an exemplary box in accordance with the ISO base media file format;

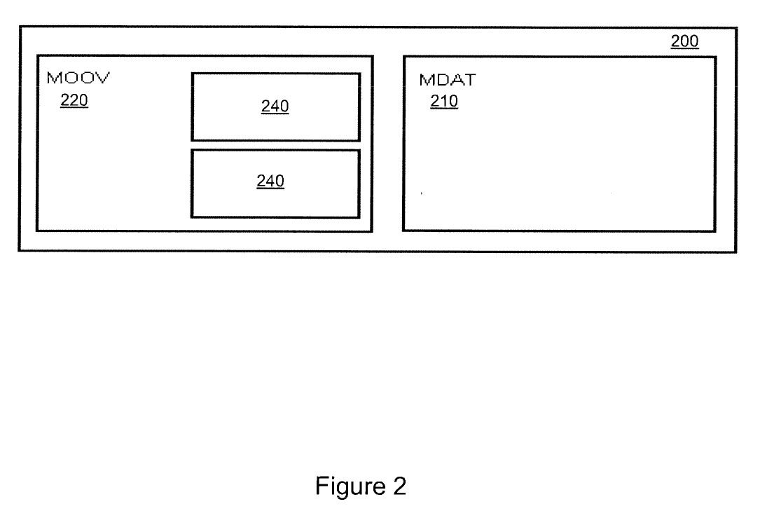

FIG. 3 is an exemplary box illustrating sample grouping;

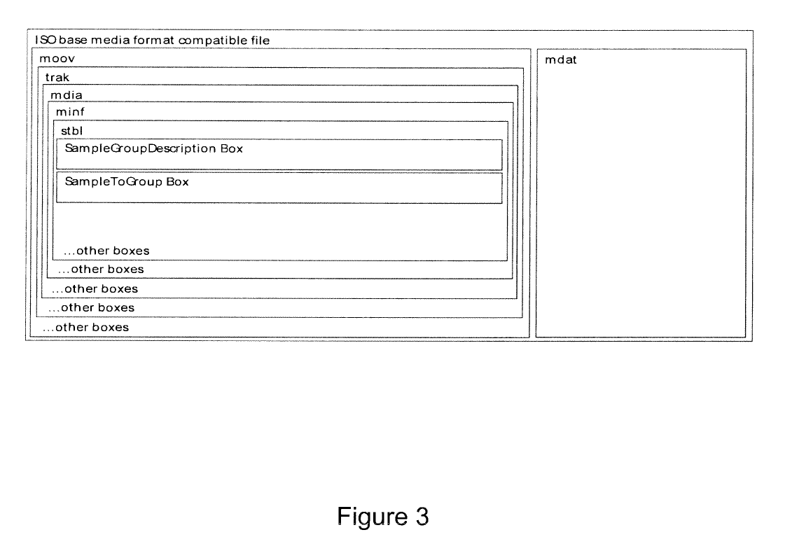

FIG. 4 illustrates an exemplary box containing a movie fragment including a SampletoToGroup box;

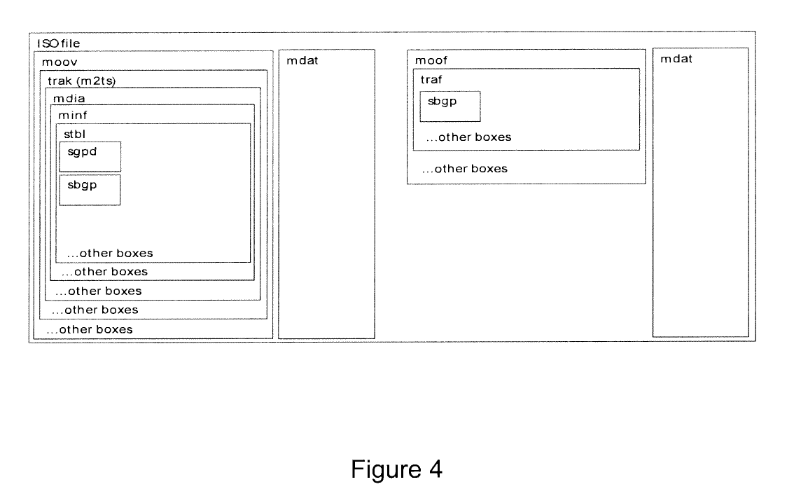

FIG. 5 illustrates a graphical representation of an exemplary multimedia communication system within which various embodiments be implemented;

FIG. 6 is a flow chart illustrating a method of organizing media and/or multimedia data in accordance with various embodiments;

FIG. 7 is a flow chart illustrating a method of accessing media data is illustrated in accordance with various embodiments;

FIG. 8 is a flow chart illustrating a method of decoding media data and accessing indexes is illustrated in accordance with various embodiments;

FIG. 9 is a perspective view of an electronic device that can be used in conjunction with the implementation of various embodiments; and

FIG. 10 is a schematic representation of the circuitry which may be included in the electronic device of FIG. 9.

### DETAILED DESCRIPTION OF VARIOUS EMBODIMENTS

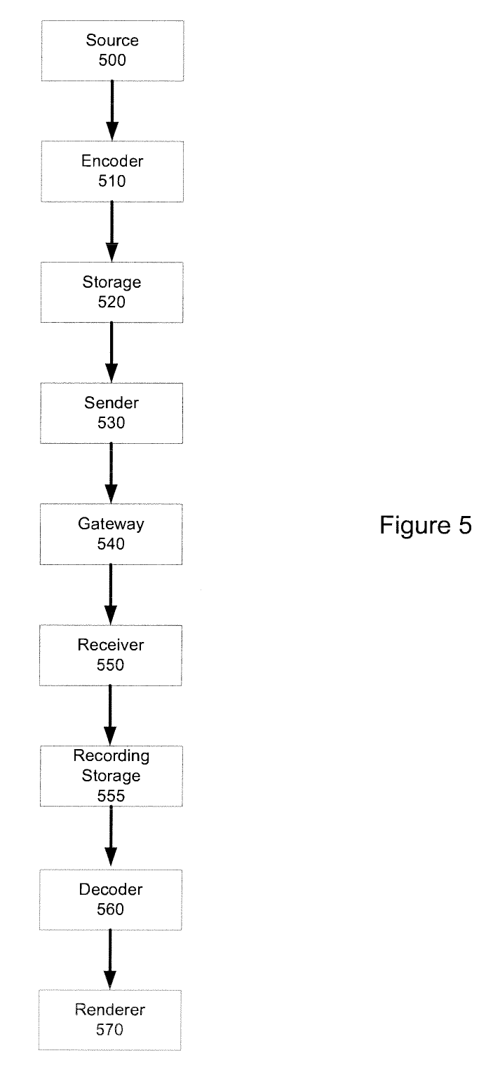

FIG. 5 is a graphical representation of a generic multimedia communication system within which various embodiments of the present invention may be implemented. As shown in FIG. 5, a data source 500 provides a source signal in an analog, uncompressed digital, or compressed digital format, or any combination of these formats. An encoder 510 encodes the source signal into a coded media bitstream. It should be noted that a bitstream to be decoded can be received directly or indirectly from a remote device located within virtually any type of network. Additionally, the bitstream can be received from local hardware or software. The encoder 510 may be capable of encoding more than one media type, such as audio and video, or more than one encoder 510 may be required to code different media types of the source signal. The encoder 510 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in FIG. 5 only one encoder 510 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream is transferred to a storage 520. The storage 520 may comprise any type of mass memory to store the coded media bitstream. The format of the coded media bitstream in the storage 520 may be an elementary self-contained bitstream format, or one or more coded media bitstreams may be encapsulated into a container file. Some systems operate “live”, i.e. omit storage and transfer coded media bitstream from the encoder 510 directly to the sender 530. The coded media bitstream is then transferred to the sender 530, also referred to as the server, on a need basis. The format used in the transmission may be an elementary self-contained bitstream format, a packet stream format, or one or more coded media bitstreams may be encapsulated into a container file. The encoder 510, the storage 520, and the server 530 may reside in the same physical device or they may be included in separate devices. The encoder 510 and server 530 may operate with live real-time content, in which case the coded media bitstream is typically not stored permanently, but rather buffered for small periods of time in the content encoder 510 and/or in the server 530 to smooth out variations in processing delay, transfer delay, and coded media bitrate.

The server 530 sends the coded media bitstream using a communication protocol stack. The stack may include but is not limited to Real-Time Transport Protocol (RTP), User Datagram Protocol (UDP), and Internet Protocol (IP). When the communication protocol stack is packet-oriented, the server 530 encapsulates the coded media bitstream into packets. For example, when RTP is used, the server 530 encapsulates the coded media bitstream into RTP packets according to an RTP payload format. Typically, each media type has a dedicated RTP payload format. It should be again noted that a system may contain more than one server 530, but for the sake of simplicity, the following description only considers one server 530.

The server 530 may or may not be connected to a gateway 540 through a communication network. The gateway 540 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. Examples of gateways 540 include multipoint conference control units (MCUs), gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 540 is called an RTP mixer or an RTP translator and typically acts as an endpoint of an RTP connection.

The system includes one or more receivers 550, typically capable of receiving, de-modulating, and de-capsulating the transmitted signal into a coded media bitstream. The coded media bitstream is transferred to a recording storage 555. The recording storage 555 may comprise any type of mass memory to store the coded media bitstream. The recording storage 555 may alternatively or additively comprise computation memory, such as random access memory. The format of the coded media bitstream in the recording storage 555 may be an elementary self-contained bitstream format, or one or more coded media bitstreams may be encapsulated into a container file. If there are many coded media bitstreams, such as an audio stream and a video stream, associated with each other, a container file is typically used and the receiver 550 comprises or is attached to a container file generator producing a container file from input streams. Some systems operate “live,” i.e. omit the recording storage 555 and transfer coded media bitstream from the receiver 550 directly to the decoder 560. In some systems, only the most recent part of the recorded stream, e.g., the most recent 10-minute excerption of the recorded stream, is maintained in the recording storage 555, while any earlier recorded data is discarded from the recording storage 555.

The coded media bitstream is transferred from the recording storage 555 to the decoder 560. If there are many coded media bitstreams, such as an audio stream and a video stream, associated with each other and encapsulated into a container file, a file parser (not shown in the figure) is used to decapsulate each coded media bitstream from the container file. The recording storage 555 or a decoder 560 may comprise the file parser, or the file parser is attached to either recording storage 555 or the decoder 560.

The codec media bitstream is typically processed further by a decoder 560, whose output is one or more uncompressed media streams. Finally, a renderer 570 may reproduce the uncompressed media streams with a loudspeaker or a display, for example. The receiver 550, recording storage 555, decoder 560, and renderer 570 may reside in the same physical device or they may be included in separate devices.

Various embodiments provide systems and methods for using sample numbers to pair timed metadata samples with media or hint samples. In other words, a timed metadata sample can be paired with media or hint samples since a sample number contained in the time media sample is provided relative to the appropriate media or hint track. Additionally, an offset of sample numbers, applicable to scenarios where a plurality of timed metadata samples exist, may be added to the provided sample number to obtain the actual sample number within the media or hint track. Because the sample number offset is utilized, as described above, sample numbers in timed metadata samples need not be overwritten after the insertion or removal of samples. Hence, various embodiments can, for example, simplify editing operations, especially with respect to the removal of the beginning of a recording, which can oftentimes be among the most used features of applicable editing operations.

It should be noted that the syntax and semantics presented below to enable the pairing of timed metadata with media and/or hint samples, and the use of sample number offsets, are described in the context of the DVB file format as well as other indexing mechanisms for the DVB file format. However, various embodiments need not be limited to the syntax and semantics described herein, and are applicable to other file formats as well. That is, various embodiments may be implemented in various systems and methods for effectuating the association of any two “samples”, wherein a “sample” is associated to a timeline or sequence order with respect to other samples.

A timed metadata track in accordance with various embodiments utilizes a sample entry such as the following:

```
abstract class IndexSampleEntry( ) extends MetadataSampleEntry
(‘ixse’) {
  unsigned int(16) program_number;
  unsigned int(16) entry_count;
  int(32) sample_number_offset;
  for (i = 1; i <= entry_count i++)
    unsigned int(32) index_type_4cc;
}
```

The IndexSampleEntry indicates the types of indexes that may be present in samples associated with this particular sample entry. The program_number identifies a program within an MPEG-2 transport stream. If the entry_count is equal to 0, any indexes may be included in samples associated with this sample entry. If the entry_count is greater than 0, a loop of index_type_{—}4 cc values is given and each value of index_jype_{—}4 cc indicates a four-character code for a box that may be present in samples associated with this sample entry. If there are many timed metadata tracks for a reception hint track, index_jype_{—}4 cc values can be used to locate the track containing the desired indexes. Furthermore, the sample_number_offset specifies an offset to be added to the sample_number in the associated timed metadata samples to obtain the sample number in the referred track. It should be noted that other mechanisms than the sample entry described above are available for associating sample_number_offset to multiple samples. For example, a new box can be introduced in the Sample Table Box to contain sample number_offset. The sample number_offset in the new box applies to all samples referred by the respective Movie Box or Movie Fragment Box. Alternatively, a new field can be included in a Track Header Box and Track Fragment Header Box to contain sample_number_offset for the samples referred by the Track Box or Track Fragment Box, respectively.

An example of the sample format for a timed metadata track containing indexes and segmented metadata is given below:

```
aligned(8) class IndexSample {
  unsigned int(32) sample_number;
  box index_box[ ];
}
```

The sample in the reception hint track associated with the given indexes has a sample number equal to sample_number+sample_number_offset. The IndexSample contains zero or more index boxes, where the four-character code for the included index boxes is among those indicated by the associated sample entry.

Examples of index boxes which can be used with various embodiments are as follows:

| abstract aligned(8) class DVBIndexBox (type) extends Box(type) { | |
|---|---|
| unsigned int(4) | time_accuracy; |
| unsigned int(4) | sample_accuracy; |
| if(time_accuracy >= 8) | |
| unsigned int(32) | max_timing_inaccuracy; |
| if(sample_accuracy >= 8) | |
| unsigned int(32) | max_sample_accuracy; |
| } | |

The following values are specified for time_accuracy and sample_accuracy: 0x0: accurate, 0x1: unspecified, 0x2: heuristic, 0x3: reserved (no maximum provided), 0x4-0x7: application-specific (no maximum provided), 0x8: maximum inaccuracy specified, 0x9: reserved (maximum inaccuracy provided), 0xA-0xF: application-specific (maximum inaccuracy provided).

```
aligned(8) class DVBVideoIndex extends DVBIndexBox(‘idvi’) {
  unsigned int(8)  video_event_mask;
  unsigned int(24)  video_event_length;
};
```

The video_event_mask is a bit mask indicating the video event(s) that start in the indicated sample, as per table 1, below.

TABLE 1
Mask values used for video_event_mask

| Mask | Meaning |
|---|---|
| 0x01 | video decode start point (e.g. a Random Access Point) |
| 0x02 | Self decodable picture (e.g. I frame) |
| 0x04 | Reference Picture |
| 0x08 | P Picture |
| 0x10 | B Picture |

The video_event_length is indicative of the number of samples (transport packets) that make up this video picture, including the current packet. The value ‘0’ shall be used to mean “unknown”.

Additionally, the Sync Sample Box can also carry the indexes to the events of type 0x01.

| aligned(8) class DVBPCRIndex extends DVBIndexBox(‘idpi’) { | |
|---|---|
| unsigned int(1) | PCR_discontinuity_flag; |
| unsigned int(5) | reserved_0; |

unsigned int(42) PCR_Value;
}

The PCR_discontinuity_flag is a field that shall be set to ‘1’ if there is a program clock reference (PCR) discontinuity in the associated PCR event. Otherwise, it shall be set to ‘0’

The PCR_value: the 27 MHz value extracted from the PCR that is indexed, i.e. as per equation (2-1) in ISO/IEC International Standard 13818-1.

aligned(8) class DVBPolarityChange extends DVBIndexBox(‘idpc’) {
unsigned int(8) polarity;
}

The polarity refers to the polarity of the associated event, as per table 2, below:

TABLE 2
Interpretation of Polarity values

| Value | Meaning |
|---|---|
| 0 | Clear |
| 1 | Odd polarity |
| 2 | Even polarity |

The values of Table 2 above indicate new, applicable polarity values, where the timed metadata sample corresponds to the first reception hint sample with this new polarity. It should be noted, however, that a polarity change index shall only be deemed to occur when the polarity of a stream of packets on a given PID changes, and not when it changes between packets of different PIDs.

With the polarity specified as below, the ca_event_data shall be indicative of the bytes that comprise the packet carrying the conditional access (CA) event. Often, though not always, this will be an entitlement control message (ECM). The ca_event_data continues until the end of the box and the length of the ca_event_data can be determined from the length of the box.

| aligned(8) class DVBCAIndex extends DVBIndexBox(‘idci’) { | |
|---|---|
| unsigned int(8) | polarity; |
| unsigned int(8) | ca_event_data[ ]; |
| } | |

Yet another index box relating to timelines is presented below:

| aligned(8) class DVBTimecodeIndex extends DVBIndexBox(‘idtc’) { | |
|---|---|
| unsigned int(8) | timeline_id; |
| unsigned int(2) | reserved_0; |
| unsigned int(6) | tick_format; // as per table 6 in TR 102 823 |
| unsigned int(32) | absolute_ticks; |
| } | |

The timeline_id is an identifier of the timeline. The tick_format is a field that specifies the format that the absolute_ticks field shall take. The absolute_ticks is a timecode, coded as indicated by the field tick_format.

The index box related to section updates is as follows:

aligned(8) class DVBSectionUpdateIndex extends DVBIndexBox(‘idsu’) {

| | |
|---|---|
| unsigned int(8) | table_id; |

| | |
|---|---|
| unsigned int(16) | table_id_extension; |

| | |
|---|---|
| unsigned int(8) | section_no; |

| | |
|---|---|
| unsigned int(n*8) | section_data; // optional |
| } | |

The table_id is the table id of the section version update that is being indexed. The table_id_extension is the extension (or program_number for a program map table (PMT), or transport_stream_id for a program association table (PAT)) from the section version update that is being indexed. The section_no refers to the section number to which this update applies. The section_data is a field that may not be present. However, if this field is present, it contains the section data of the new version. The section data shall continue until the end of the box, and the length of the section_data can be determined from the length of the box.

Yet another index box that may be utilized in accordance with various embodiments is specified below:

| aligned(8) class DVBIDIndex extends DVBIndexBox(\grave{ }didi\grave{ }) { | |
|---|---|
| unsigned int(5) | reserved; |
| unsigned int(3) | running_status; // As per table 105 |
| in 102 323 | |

| | |
|---|---|
| unsigned int(24) | ID_Table_index; |
| } | |

The running_status is a field that indicates the status of the ID that is referenced by the ID_Table_index field (e.g, if the ID is running or paused). The value of this field is defined in the ETSI TS 102 323 contribution document. The ID_Table_index is an index into the DVBIDTableBox which indicates the ID that applies at this location with the indicated running_status.

Still another index table for use with various embodiments is as follows, where the ID_count is the number of IDs that follow in the DVBIDTable and the ID is the uniform resource identifier (URI)-formatted ID.

```
aligned(8) class DVBIDTable extends FullBox(\grave{ }didt\grave{ }, version = 0, 0) {
  unsigned int(32)  ID_count;
  for(i=0;i<ID_count;i++) {
    string  ID;  //in URI Format
  }
}
```

It should be noted that other examples of index boxes (which have not been previously proposed in relation to the DVB file format) are specified as follows:

aligned(8) class SDPUpdate extends DVBIndexBox(‘idsd’) {
string sdp_text;
}

The sdp_text is a null-terminated string containing an SDP description that is valid starting from the indicated sample.

The following index box relates to key updates and messages:

aligned(8) class KeyUpdate extends DVBIndexBox(‘idkm’) {
string key_message;
}

The key_message contains a cryptographic key to be used for deciphering the packet payloads starting from the related reception hint sample.

An error index box can be specified as follows:

```
aligned(8) class ErrorIndex extends DVBIndexBox(‘idei’) {
  unsigned int(2) packet_header_error;
  unsigned int(2) packet_payload_error;
  unsigned int(2) packet_sequence_gap;
  unsigned int(2) reserved;
}
```

The packet_header_error is an error value, where a value 0x0 indicates that the packet header contains no errors. A value 0x1 indicates that the packet header may or may not contain errors. A value 0x2 indicates that the packet header contains errors, and value 0x3 is reserved. The packet_payload_error is indicative of another error value, where a value 0x0 indicates that the packet payload contains no errors. A value 0x1 indicates that the packet payload may or may not contain errors, a value 0x2 indicates that the packet payload contains errors, and again, a value 0x3 is reserved. The packet_sequence_gap is indicative of a following order, where a value 0x0 indicates that the packet immediately follows the previous packet in the reception hint track in transmission order. A value 0x1 indicates that the packet may or may not immediately follow the previous packet in the reception hint track in transmission order. A value 0x2 indicates that the packet does not immediately follow the previous packet in the reception hint track in transmission order, e.g., that a there is at least one missing packet preceding this packet. A value 0x3 is reserved.

When timed metadata tracks for indexes or segmented metadata are created, the following practices can be followed with regard to file generation.

First, a one timed metadata track can be created for program-specific indexes and the metadata of a single-program MPEG-2 transport stream. Program-specific indexes and metadata can apply equally to audio and video streams of a program and to any other potential components of the program, such as subtitle streams.

Second, a one timed metadata track per program can be created for program-specific indexes and the metadata of a multi-program MPEG-2 transport stream. In other words, a timed metadata track can contain the metadata of only one program. As a result, the program can be identified by its program_number value, which is a 16-bit unique identifier for programs within an MPEG-2 transport stream, used e.g., in PATs and PMTs of an MPEG-2 transport stream. The parameter program_number can be included e.g. in the sample entry structure for timed metadata tracks associated with MPEG2-TS reception hint tracks.

Third, a one timed metadata track can be created for media-specific indexes of each elementary stream of an MPEG2-TS program. Media-specific indexes apply only to a particular media type. For example, they can be indications of reference and non-reference frames of video or indications of the temporal scalability level of video.

Fourth, a one timed metadata track can be created for media-specific indexes for an RTP stream.

Fifth, a one timed metadata track can be created for program-specific indexes of multiple RTP streams. The timed metadata track is associated with the RTP reception hint tracks using track references. Alternatively, the timed metadata track can be associated with the “master” reception hint track with a track reference and the other associated reception hint tracks are indicated through the TrackRelationBox as described above.

Lastly, although one program-specific timed metadata track and one media-specific timed metadata track per elementary media stream is often preferable, more than one timed metadata tracks can be created. For example, if an alternative timeline for the program is provided subsequently to the program itself, it is more practical from the file arrangement point of view to create a new timed metadata track for the provided timeline. A receiver may also create a “multiplexed” timed metadata track including many index types, and “specialized” timed metadata tracks, each including one index type. Rather than creating separate samples for a “specialized” timed metadata track, a receiver can create the boxes in the sample table box of a “specialized” timed metadata track such a way that the samples of the “specialized” timed metadata tracks are actually subsets of the samples of the “multiplexed” timed metadata track. In other words, the same pieces of sample data are referred to multiple times from different timed metadata tracks.

Additionally, a receiver can operate as follows, as a response to each received packet. First, the received packet can be converted to a reception hint sample in the mdat box. Second, indexes and segmented metadata can be derived, where associated metadata sample(s), if any, can be written to the mdat box (immediately after the corresponding reception hint sample). Third, boxes can be updated within the track header of the reception hint track. Fourth, boxes can be updated within the track header of the timed metadata track. Finally, if the memory reserved for track header is about to be fully occupied (and cannot be dynamically re-allocated), a new movie fragment can be started.

It should be noted that a receiver with a greater amount of buffer memory may arrange several metadata samples and reception hint samples in continuous chunks of memory and, therefore, realize savings with regard to the storage space required for the sample to chunk box and the chunk offset box.

It should also be noted that indexes and segmented metadata may have the following characteristics when it comes to reception hint samples that are associated with them: (1) An index may indicate a characteristic to be valid from the associated reception hint sample onwards, usually until the next index of the same type. For example, an index may indicate a polarity change of scrambling in MPEG-2 transport stream; (2) An index may indicate a characteristic of a single reception hint sample or an event that is synchronized with a reception hint sample. A bookmark is an example of such an index; (3) An index may indicate a characteristic of the stream in between the associated reception hint sample and the previous reception hint sample. An indication of missing packets is such an index; (4) An index may indicate a characteristic of a coded media sample. It should be noted that timed metadata tracks described herein are associated to reception hint samples, reception hint samples do not usually contain exactly one media sample, and data for one media sample may reside in contiguous reception hint samples (e.g., because elementary audio and video streams are multiplexed in an MPEG-2 transport stream). Consequently, there are at least two options as to how media samples can be indexed, e.g., an index can be associated only with the first reception hint sample containing data for a media sample, or an index is associated with all reception hint samples containing data for a media sample.

As described below, various embodiments can be utilized to simplify editing operations including, but not limited to, the removal of the beginning of a recording, the removal of a section in the middle of a recording, the concatenation of two recordings, and the insertion of a section of samples in the middle of a recording.

An end-user may want to remove the beginning of a recording, e.g., because a scheduled recording may not exactly match with the actual start time of the desired program, and consequently, the beginning of a recording contains the previous program. In the following, the sample number of the last reception hint sample to be deleted is s₂.

Samples in the reception hint track are removed from the beginning until s₂, inclusive. The removal of samples from a track may involve, but are not limited to the following operations. For example, rewriting the Movie Header Box (especially its modification_time and duration syntax elements) may be performed, as is rewriting the Track Header Box (especially its modification_time and duration syntax elements), and rewriting the Media Header Box (especially its modification_time and duration syntax elements). Additionally, the removal of the beginning of a recording may involve rewriting the Decoding Time to Sample Box (and similarly the Composition Time to Sample Box, if present) in such a way that the information of the removed samples is removed from the box. The rewriting of the Sample Size Box or Compact Sample Size Box, whichever is present, in such a way that the information of the removed samples is removed from the box may also be involved.

Other operations can include the rewriting of the Sample to Chunk Box in such a way that the information of the removed samples is not referred by the box. Rewriting of the Chunk Offset Box in such a way that chunks that contain only samples that are removed are not included in the box, while other values of chunk_offset are written in such a way that removed samples are not referred to is yet another operation that may be performed. Furthermore, the rewriting of the Sync Sample Box and Shadow Sync Sample Box, if present, in such a way that indicated sync samples that are among the removed ones are no longer referred to by the boxes is a possibility, as is the rewriting of Track Fragment Header Boxes and Track Fragment Run Boxes, if any, in such a way that removed samples are not referred. It should be noted that not all boxes that are to be recreated have been described above. Therefore, similar operations may be needed for additional boxes as well.

Still other operations may include the rewriting of boxes within the moov box or the moof box, which may result in smaller boxes than previously in terms of bytes. Hence, the freed space in the file may be replaced by a Free Space Box or the file may be compacted in such a way that boxes are re-located within a file. Also, the re-location of boxes, especially the mdat box, may cause the rewriting of byte offsets relative to the position in the file level (i.e., byte offsets counted from the start of the file). Such byte offsets are used, e.g., in the Chunk Offset Box.

Moreover, removed samples in the track can be “physically removed”, i.e., the data in the mdat box can be reorganized so that the removed samples are no longer present in the mdat box. Similarly, and as described above, byte offsets from the start of the file must then be rewritten. Alternatively, the space for removed samples may not be deallocated, but instead, removed samples are no longer referred to by any box in the moov and/or moof boxes.

If there is more than one associated reception hint track (e.g., audio and video RTP reception hint track), samples from both reception hint tracks are removed according to the composition times (RTP timestamps). Samples to be removed from the timed metadata track are found by traversing the timed metadata samples until sample_number+sample_number_offset>s₂. Samples from the start of the timed metadata track until the last sample having sample_number+sample_number_offset <=s₂ are removed from the timed metadata track as well. Removal of samples from a timed metadata track is similar as removal of samples from a track, which was described above. The sample_number_offset in the sample entry for the timed metadata track is set to prev_sample_number_offset+(s₁−s₂−1), where prev_sample_number_offset is equal to the sample_number_offset that earlier applied to timed metadata samples subsequent to the removed section, and s₁ is the sample number of the first sample. The remaining timed metadata samples need not be rewritten. If there were more than one sample entry in the Sample Description Box, the value of sample_number_offset in all the sample entries is modified as described above.

With regard to removing sections from the middle of a recording, for example, in response to automatic advertisement detection and removal, the sample number of the first and last reception hint sample are s₁ and s₂, respectively, in the following description. Samples from the reception hint track are removed in the same or in a substantially similar manner as described above with respect to the removal of the beginning of a recording.

The first sample to be removed from the timed metadata track is the first one for which sample_number+sample_number_offset >=s₁. The last sample to be removed from the timed metadata track is the last one for which sample_number+sample number_offset <=s₂. Additionally, a new sample entry is created for the Sample Description Box of the timed metadata track. The new sample entry describes the sample format of the samples after the deleted section. Chunks that follow the removed section are associated with the new sample entry through the Sample to Chunk Box. The sample_number_offset in the new sample entry for the timed metadata track is set to prev_sample_number_offset+(s₁−s₂−1), where prev_sample_number_offset is specified as described above. If there were more than one sample entry that originally described both samples before the deleted section and after the deleted section, a new sample entry is created for each one of them and the value of sample_number_offset in all the sample entries is derived as described above.

As to concatenating two recordings, two recording may be concatenated into one, e.g., in order to combine episodes of the same movie or series to one file, where the insertion of samples to a track may involve, but are not limited to, the following operations: (1) Rewriting the Movie Header Box (especially its modification_time and duration syntax elements), (2) Rewriting the Track Header Box (especially its modification_time and duration syntax elements); (3) Rewriting the Media Header Box (especially its modification_time and duration syntax elements); (4) Rewriting the Decoding Time to Sample Box (and similarly the Composition Time to Sample Box, if present) to incorporate the inserted samples; (5) Rewriting the Sample Size Box or Compact Sample Size Box, whichever is present, to incorporate the inserted samples; (6) Rewriting the Sample to Chunk Box such a way that the inserted samples are included; (7) Rewriting the Chunk Offset Box to incorporate the inserted samples, where the inserted samples are generally contained in chunks that are separate from the chunks originally present in the file; (8) Rewriting the Sync Sample Box and Shadow Sync Sample Box, if present, to incorporate the inserted samples; and (9) Rewriting Track Fragment Header Boxes and Track Fragment Run Boxes, if any, to incorporate the inserted samples, where it should be noted that if the section inserted to a file is aligned with fragment boundaries, i.e., not included into the middle of a fragment, insertion can be done by including a new fragment or fragments to the file. It should further be noted that not all boxes that are to be recreated have been described above. Therefore, similar operations may be needed for additional boxes as well.

Additionally, concatenation may involve rewriting boxes within the moov box or the moof box, which may result in larger boxes than previously realized in terms of bytes. If there are no free space boxes from which to allocate the increased storage space, subsequent boxes in the file may be re-located. The re-location of boxes, especially the mdat box, can cause the rewriting of byte offsets relative to the position in the file level (i.e., byte offsets counted from the start of the file), where such byte offsets are used e.g. in the Chunk Offset Box.

All tracks of the second file in the timeline are inserted to the end of the corresponding tracks of the first file with the procedure(s) described above. Two sample entries are included in the Sample Description Box for the timed metadata track of the concatenated file. The first sample entry corresponds to the original file appearing first in the timeline. The first sample entry remains unchanged. The second sample entry corresponds to the original file appearing last in the timeline. The second sample entry remains otherwise unchanged, but the value of sample number_offset is set to prev_sample number_offset+the number of samples in the reception hint track of the first file. If the original files contained more than one sample entry for the timed metadata tracks, then all of those sample entries are included in the Sample Description Box of the concatenated file, and all of the sample entries of the second file are modified as described above.

As noted above, the insertion of a section of samples in the middle of a recording is another editing operation that can be simplified by various embodiments. In such an operation described below, the sample number of the reception hint samples immediately preceding and following the inserted samples are s₁ and s₂, respectively, and the sample number of the first and last reception hint sample to be inserted in its original file are s₃ and s₄, respectively. Samples are inserted into a reception hint track in a substantially similar manner as already described above. Samples corresponding to s₁ and s₂ are located from the timed metadata track as described above in reference to process(es) associated with the “removal of a section in the middle of a recording”. Timed metadata samples corresponding to the inserted samples are inserted to the timed metadata track also as described above, and a sample entry or entries that were originally used for the timed metadata of the inserted samples are included in the file. The value of sample_number_offset in these sample entries is set to prev_sample_number_offset+s₃+s₁+1. A second copy of sample entry or entries is created for sample entries that were originally used for the timed metadata both before sample s₂ and for or subsequent to sample s₂. The value of sample number_offset for the sample entries describing samples starting from s₂ is set to prev_sample_number_offset+s₄−s₃+1.

As indicated above, various embodiments presented herein are described in the context of a timed-metadata-track-based indexing mechanism for the DVB file format, but can be applied more generally as follows. Various embodiments are applicable to other indexing proposals for the DVB file format that use sample numbers to synchronize indexes to reception hint samples, e.g., the DVBIndexTable Box, as well as sample events and sample properties. The sample_number_offset can be carried in the DVBIndexTable Box.

If there is a need to have more than one value of sample_number_offset applicable to the indexes within a DVBIndexTable Box, e.g., if an editing insertion or cut point occurred in the middle of the indexes in the DVBIndexTable Box, various methods including, but not limited to the following, can be performed. First, movie fragments can be arranged to match insertion and cut points such a way that only on sample_number_offset value is needed for the DVBIndexTable Box for each movie fragment. Second, more than one DVBIndexTable Box can appear within the moov box or within any moof box. Each one of these DVBIndexTable Boxes carries indexes that correspond to non-overlapping sections of reception hint samples, and each DVBIndexTable box contains one sample_number_offset value. Third, more than one value of sample_number_offset may be present in a DVBIndexTable Box, each value of sample_number_offset applicable to one or more indexes that are indicated with the sample_number_offset value.

Because there is one Sample to Event or Sample to Property Box for each index type, sample_number values would normally be updated in all of these boxes after editing operations. To avoid this updating, a new Referenced Sample Number Offset Box, included in Sample Table Box or Track Fragment Box, can be specified as follows:

```
aligned(8) class ReferencedSampleNumberOffsetBox extends
Box(‘rsno’) {
  unsigned int(32) entry count;
  for(i=1; i<=entry_count; i++) {
    unsigned int(32) last_sample_number;
    int(32) sample_number_offset;
  }
}
```

The last_sample_number and sample_number_offset for entry i can be set equal to last_sample_number[i] and sample_number_offset[i], respectively. The last_sample_number[0] can be set equal to 0. When referring to samples in the associated reception hint tracks, value sample_number_offset[m] shall be added to all those values of sample_number in any Sample to Event Box and any Sample to Property Box that satisfy the inequation last_sample_number[m−1]<sample_number<=last_sample_number[m]. If sample_number_offset[n] is equal a pre-defined constant, such as 2̂31−1, then the events and properties associated with sample numbers in the range of last_sample_number[n_l]+1 to last_sample_number[n], inclusive, are not valid. Such a process can be used to mark indexes corresponding to removed samples invalid without rewriting Sample to Event Boxes and Sample to Property Boxes.

It should be noted that various embodiments are also applicable to indexes that describe types of tracks other than reception hint tracks. For example, various embodiments are applicable to indexes describing media tracks, virtual media tracks, server hint tracks, and timed metadata tracks. Moreover, it should be noted that devices and/or systems in which various embodiments are applied/implemented do not necessarily involve the recording of received streams of data.

Various embodiments are also applicable to other types of timed metadata besides DVB indexes and segmented metadata, as well as to other types of relationships than those involving metadata samples describing other types of samples. That is, various embodiments are generally applicable to any relationship where two pieces of data of residing in different ordered sequences of pieces of data are associated with each other.

Additionally, various embodiments are applicable to other types of association methods than those involving a sample number. For example, if a timed metadata sample were associated with a reception hint sample by including the (absolute) decoding timestamp of the reception hint sample in the timed metadata sample, the structures presented herein can be modified to contain a decoding_time_offset rather than sample_number_offset. Similarly, if a byte address relative to the beginning of a file or any distinguishable point in the file, such as the start of an mdat box, is used for the association of a timed metadata sample to a reception hint sample, the structures presented herein can be modified to contain a byte_address_offset rather than sample_number_offset.

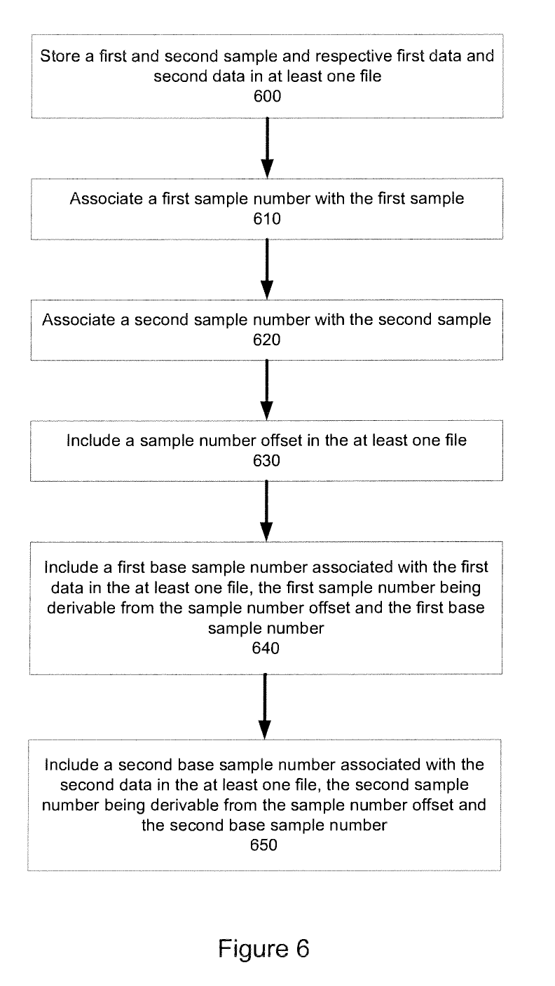

FIG. 6 is a flow chart illustrating an exemplary method of organizing media and/or multimedia data in accordance with various embodiments. At 600, a first and second sample is stored in a file, wherein the first and second samples can refer to, for example, a media or hint track. The first sample is associated with a first piece of data and the second sample is associated with a second piece of data, where the first and second pieces of data are representative portions of the media or hint tracks. It should be noted that the first piece of data and the second piece of data are not identical. In other words, the metadata (i.e., the first and second pieces of data) are not “static.” At 610, a first sample number is associated with the first sample and at 620, a second sample number is associated with the second sample, where the first and second sample numbers are contained in, for example, a timed metadata sample, and are relative to the media and/or hint tracks. A sample number offset is included in the file at 630. At 640, a first base sample number associated with the first piece of data is included in the file. It should be noted that the first sample number is to be derivable from the sample number offset and the first base sample number. Therefore, as described above, the sample number offset, applicable to a plurality of timed metadata samples, can be added to the first base sample number to obtain the first sample number, i.e., the actual first sample number within the media or hint track. At 650, a second base sample number associated with the second piece of data is included in the file, where the second sample number is to be derivable from the sample number offset and the second base sample number in the same manner as described with regard to the first base sample number.

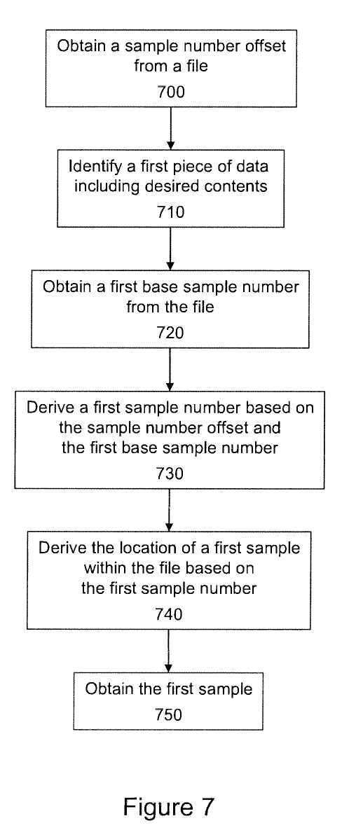

Indexes can be used for non-sequential access of media data stored as media tracks or reception hint tracks. For example, the playback of a file can be started from a sample associated with a certain index value. In FIG. 7, a flow chart of an exemplary method of accessing media data is illustrated in accordance with various embodiments. At 700, a sample number offset is obtained from a file. At 710, a first piece of data is identified from the file, where the first piece of data contains, e.g., a desired index value for non-sequential access of a media track or a hint track. At 720, a first base sample number is obtained from the file. Usually, the storage location of the first base sample number is related to the storage location of the first piece of data. For example, the first base sample number and the first piece of data may be stored contiguously to together, form a timed metadata sample. At 730, a first sample number is derived from the sample number offset and the first base sample number. At 740, the location of a first sample within the file is derived based on the information given in the media track or the hint track and the first sample number. Derivation of the location can require the following steps: First, parsing the information in the Sample to Chunk Box reveals, based on the sample number, the chunk number of the chunk in which the sample resides. Second, the Chunk Offset Box reveals the byte offset relative to the start of the file for the chunk. Third, the Sample Size Box reveals the byte offset of the sample relative to the start of the chunk, based on the sample number. If the sample resides in a movie fragment, the Track Fragment Header Box and the Track Fragment Run Box reveal similar information. At 750, the first sample is accessed based on the location of the sample within the file.

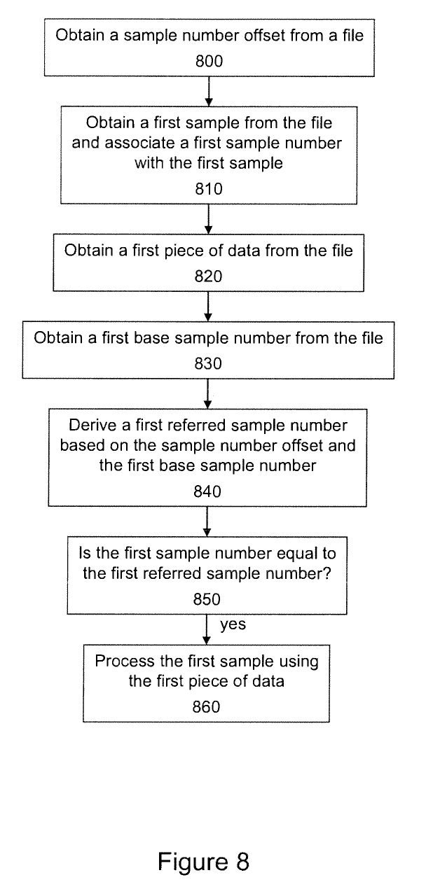

Indexes can also be required or helpful in decoding and playback of a file. For example, the decoding of a file can require handing of key messages included as indexes in a timed metadata track. Key messages are necessary for decrypting a stream stored in a reception hint track. In FIG. 8, a flow chart of an exemplary method of decoding media data and accessing indexes is illustrated in accordance with various embodiments. At 800, a sample number offset is obtained from a file. At 810, a first sample from a media track or a hint track is obtained. The first sample number is associated with a first sample number based on the sample number of the preceding sample, if any. If no sample precedes the first sample, the first sample number is set to a pre-defined value. At 820, a first piece of data is obtained from the file. At 830, a first base sample number is obtained from the file. Usually, the storage location of the first base sample number is related to the storage location of the first piece of data. For example, the first base sample number and the first piece of data may be stored contiguously and form a timed metadata sample. At 840, a first referred sample number is derived from the sample number offset and the first base sample number. At 850, the first sample number and the first referred sample number are compared. If the first sample number and the first referred sample number are the same, the first piece of data is used to process the first sample at 860. Processing the first sample may include decrypting or error-conscious decoding, for example. Steps 810 through 860 may be repeated for subsequent samples and pieces of data.

Communication devices incorporating and implementing various embodiments of the present invention may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

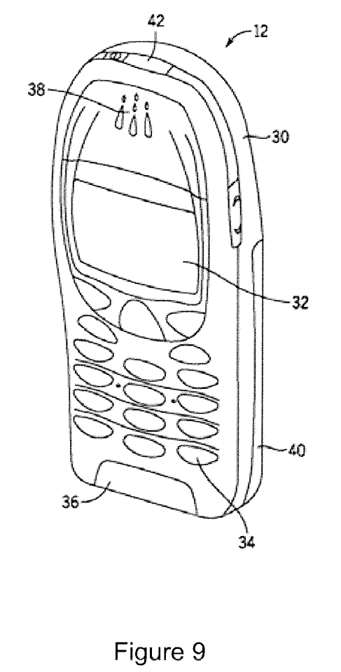

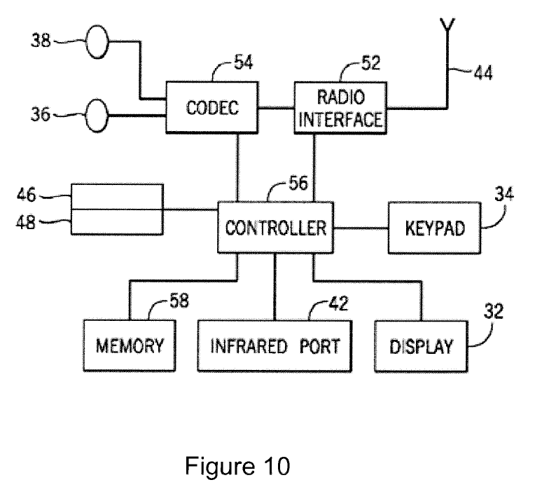

FIGS. 9 and 10 show one representative electronic device 12 within which the present invention may be implemented. It should be understood, however, that the present invention is not intended to be limited to one particular type of electronic device 12. The electronic device 12 of FIGS. 9 and 10 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56, a memory 58 and a battery 80. Individual circuits and elements are all of a type well known in the art.

Various embodiments described herein are described in the general context of method steps or processes, which may be implemented in one embodiment by a computer program product, embodied in a computer-readable medium, including computer-executable instructions, such as program code, executed by computers in networked environments. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

Various embodiments may be implemented in software, hardware, application logic or a combination of software, hardware and application logic. The software, application logic and/or hardware may reside on a chipset, a mobile device, a desktop, a laptop or a server. The application logic, software or an instruction set is preferably maintained on any one of various conventional computer-readable media. In the context of this document, a “computer-readable medium” can be any media or means that can contain, store, communicate, propagate or transport the instructions for use by or in connection with an instruction execution system, apparatus, or device.

The foregoing description of various embodiments have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method of organizing at least one of media and multimedia data in at least one file, comprising:
storing a first sample, a first piece of data, a second sample, and a second piece of data in at least one file, the at least one of the media and multimedia data including the first and second samples, the first piece of data being associated with the first sample, and the second piece of data being associated with the second sample;
associating a first sample number with the first sample;
associating a second sample number with the second sample;
including a sample number offset in the at least one file;
including a first base sample number associated with the first piece of data in the at least one file, the first sample number being derivable from the sample number offset and the first base sample number; and
including a second base sample number associated with the second piece of data in the at least one file, the second sample number being derivable from the sample number offset and the second base sample number.

2. The method of claim 1, wherein each of the first and second samples refer to an ordered sequence of pieces of data included in one of a media track and a hint track, and wherein the ordered sequence includes the first and second pieces of data.

3. The method of claim 1, wherein the first and second pieces of data are not identical.

4. The method of claim 1, wherein at least one of the first and second sample numbers is useable for editing the at least one file by removing a beginning portion of the at least one of the media and multimedia data, and wherein the removing of the beginning portion comprises removing at least one of the first and second samples by at least one of rewriting an ISO base media file format box and actually removing the at least one of the first and second samples.

5. The method of claim 1, wherein at least one of the first and second sample numbers is useable for editing the at least one file by removing a middle portion of the at least one of the media and multimedia data, and wherein the removing of the middle portion comprises removing at least one of the first and second samples by at least one of rewriting an ISO base media file format box and actually removing the at least one of the first and second samples.

6. The method of claim 1, wherein at least one of the first and second sample numbers is useable for editing the at least one file by concatenating two instances of the at least one of the media and multimedia data, and wherein the concatenating comprises at least one of rewriting and re-locating an ISO base media file format box.

7. The method of claim 1, wherein at least one of the first and second sample numbers is useable for editing the at least one file by inserting a section of samples into the at least one of the media and multimedia data.

8. A computer program product, embodied on a computer-readable medium, comprising computer code configured to perform the processes of claim 1.

9. An apparatus, comprising:
a processor; and
a memory unit communicatively connected to the processor and including:
computer code configured to store a first sample, a first piece of data, a second sample, and a second piece of data in at least one file, the first and second samples including at least one of a media and multimedia data, the first piece of data being associated with the first sample, and the second piece of data being associated with the second sample;
computer code configured to associate a first sample number with the first sample;
computer code configured to associate a second sample number with the second sample;
computer code configured to include a sample number offset in the at least one file;
computer code configured to include a first base sample number associated with the first piece of data in the at least one file, the first sample number being derivable from the sample number offset and the first base sample number; and
computer code configured to include a second base sample number associated with the second piece of data in the at least one file, the second sample number being derivable from the sample number offset and the second base sample number.

10. The apparatus of claim 9, wherein each of the first and second samples refer to an ordered sequence of pieces of data included in one of a media track and a hint track, and wherein the ordered sequence includes the first and second pieces of data.

11. The apparatus of claim 9, wherein the first and second pieces of data are not identical.

12. The apparatus of claim 9, wherein at least one of the first and second sample numbers is useable for editing the at least one file by removing a beginning portion of the at least one of the media and multimedia data, and wherein the removing of the beginning portion comprises removing at least one of the first and second samples by at least one of rewriting an ISO base media file format box and actually removing the at least one of the first and second samples.

13. The apparatus of claim 9, wherein at least one of the first and second sample numbers is useable for editing the at least one file by removing a middle portion of the at least one of the media and multimedia data, and wherein the removing of the middle portion comprises removing at least one of the first and second samples by at least one of rewriting an ISO base media file format box and actually removing the at least one of the first and second samples.

14. The apparatus of claim 9, wherein at least one of the first and second sample numbers is useable for editing the at least one file by concatenating two instances of the at least one of the media and multimedia data, and wherein the concatenating comprises at least one of rewriting and re-locating an ISO base media file format box.

15. The apparatus of claim 9, wherein at least one of the first and second sample numbers is useable for editing the at least one file by inserting a section of samples into the at least one of the media and multimedia data.

16. An apparatus, comprising:
means for storing a first sample, a first piece of data, a second sample, and a second piece of data in at least one file, the at least one of the media and multimedia data including the first and second samples, the first piece of data being associated with the first sample, and the second piece of data being associated with the second sample;
means for associating a first sample number with the first sample;
means for associating a second sample number with the second sample;
means for including a sample number offset in the at least one file;
means for including a first base sample number associated with the first piece of data in the at least one file, the first sample number being derivable from the sample number offset and the first base sample number; and
means for including a second base sample number associated with the second piece of data in the at least one file, the second sample number being derivable from the sample number offset and the second base sample number.

17. The apparatus of claim 16, wherein each of the first and second samples refer to an ordered sequence of pieces of data included in one of a media track and a hint track, and wherein the ordered sequence includes the first and second pieces of data.

18. The apparatus of claim 16, wherein the first and second pieces of data are not identical.

19. A method, comprising:
receiving at least one file representative of at least one of media and multimedia data;
obtaining an actual sample number within at least one of a media track and a hint track associated with a sample number offset and a sample number of a timed metadata sample relative to the at least one of the media track and the hint track; and
performing editing operations on the at least one of the media and multimedia data based upon the actual sample number.

20. The method of claim 19, wherein the performing of the editing operations further comprises at least one of removing a beginning portion of the at least one of the media and multimedia data, removing a middle portion of the at least one of the media and multimedia data, concatenating two instances of the at least one of the media and multimedia data, inserting a section of samples into the at least one of the media and multimedia data.

21. A computer program product, embodied on a computer-readable medium, comprising computer code configured to perform the processes of claim 19.

22. An apparatus, comprising:
a processor; and
a memory unit communicatively connected to the processor and including:
computer code configured to receive at least one file representative of at least one of media and multimedia data;
computer code configured to obtain an actual sample number within at least one of a media track and a hint track associated with a sample number offset and a sample number of a timed metadata sample relative to the at least one of the media track and the hint track; and
computer code configured to perform editing operations on the at least one of the media and multimedia data based upon the actual sample number.

23. The apparatus of claim 22, wherein the memory unit further comprises computer code configured to remove a beginning portion of the at least one of the media and multimedia data.

24. The apparatus of claim 22, wherein the memory unit further comprises computer code configured to remove a middle portion of the at least one of the media and multimedia data.

25. The apparatus of claim 22, wherein the memory unit further comprises computer code configured to concatenate two instances of the at least one of the media and multimedia data.

26. The apparatus of claim 22, wherein the memory unit further comprises computer code configured to insert a section of samples into the at least one of the media and multimedia data.

27. A method for accessing at least one of media and multimedia data from at least one file, wherein a first sample and a first piece of data are present in the at least one file, wherein the at least one of the media and multimedia data includes the first sample, and wherein the first piece of data comprises a first base sample number and data characterizing the first sample, the method comprising:
receiving a desired value for the data characterizing a sample;
parsing the first piece of data; and
subject to the data characterizing the first sample matching the desired value for the data characterizing the sample:
parsing the first base sample number;
parsing a sample number offset from the at least one file;
deriving a first sample number based on the first base sample number and the sample number offset;
locating the first sample within the at least one file based on the first sample number; and
accessing the first sample.

28. The method of claim 27, wherein the desired value comprises a desired index value.

29. The method of claim 28, wherein the accessing of the first sample comprises non-sequential access of one of a media track and a hint track based upon the desired index value

30. A computer program product, embodied on a computer-readable medium, comprising computer code configured to perform the processes of claim 27.

31. An apparatus, comprising:
a processor; and
a memory unit communicatively connected to the processor and including:
computer code configured to receive a desired value for data characterizing a sample;
computer code configured to parse a first piece of data, wherein the first piece of data is present in at least one file containing at least one of media and multimedia data to be accessed along with a first sample, wherein the at least one of the media and multimedia data includes the first sample, and wherein the first piece of data comprises a first base sample number and data characterizing the first sample; and
computer code configured to, subject to the data characterizing the first sample matching the desired value for the data characterizing the sample:
parse the first base sample number;
parse a sample number offset from the at least one file;
derive a first sample number based on the first base sample number and the sample number offset;
locate the first sample within the at least one file based on the first sample number; and
access the first sample.

32. The apparatus of claim 31, wherein the desired value comprises a desired index value.

33. The apparatus of claim 31, wherein the accessing of the first sample comprises non-sequential access of one of a media track and a hint track based upon the desired index value

34. A method for accessing data characterizing at least one of media and multimedia data from at least one file, wherein a first sample and a first piece of data are present in the at least one file, wherein the at least one of the media and multimedia data includes the first sample, and wherein the first piece of data comprises a first base sample number, the method comprising:
parsing the first sample;
deriving a first sample number based on a pre-defined numbering scheme and an order of samples including the first sample;
parsing the first base sample number;
parsing a sample number offset from the at least one file;
deriving a first referred sample number based on the first base sample number and the sample number offset; and
subject to the first sample number matching the first referred sample number, parsing the first piece of data and processing the first sample based on the first piece of data.

35. The method of claim 34, wherein the first sample refers to an ordered sequence of pieces of data included in one of a media track and a hint track and wherein the ordered sequence includes the first piece of data.

36. A computer program product, embodied on computer-readable medium, comprising computer code configured to perform the processes of claim 34.

37. An apparatus, comprising:
a processor; and
a memory unit communicatively connected to the processor and including:
computer code configured to parse a first sample, wherein the first sample and a first piece of data are present in at least one file to be accessed for data characterizing at least one of media and multimedia data, wherein the at least one of the media and multimedia data includes the first sample, and wherein the first piece of data comprises a first base sample number;
computer code configured to derive a first sample number based on a pre-defined numbering scheme and an order of samples including the first sample;
computer code configured to parse the first base sample number;
computer code configured to parse a sample number offset from the at least one file;
computer code configured to derive a first referred sample number based on the first base sample number and the sample number offset; and
computer code configured to, subject to the first sample number matching the first referred sample number, parse the first piece of data and processing the first sample based on the first piece of data.

38. The apparatus of claim 37, wherein the first sample refers to an ordered sequence of pieces of data included in one of a media track and a hint track and wherein the ordered sequence includes the first piece of data.
